(19) United States
(12) Patent Application Publication
(10) Pub. No.: US 2026/0299135 A1
(43) Pub. Date: Oct. 1, 2026

(54) DETERMINATION SYSTEM AND DETERMINATION METHOD

(71) Applicant: KOMATSU LTD., Tokyo (JP)

(72) Inventors: Ryota Ozaki, Tokyo (JP); Takuto Motomura, Tokyo (JP); Toyohisa Matsuda, Tokyo (JP)

(73) Assignee: KOMATSU LTD., Tokyo (JP)

(21) Appl. No.: 19/478,860

(22) PCT Filed: Aug. 29, 2024
(86) PCT No.: PCT/JP2024/030984

§ 371 Date: Oct. 27, 2025

(30) Foreign Application Priority Data
Aug. 31, 2023 (JP) 2023-141774

(51) Int. Cl. G01S 19/39; E02F 9/26; G01S 19/42

(52) U.S. Cl. CPC G01S 19/396; E02F 9/26; G01S 19/42

(57) ABSTRACT

The acquisition unit acquires position data indicating the position of the work vehicle based on a global navigation satellite system (GNSS). The determination unit determines the accuracy of the position data based on the vehicle body data and the position data of the work vehicle.

### TECHNICAL FIELD

The present disclosure relates to a determination system and a determination method.

The present application claims priority based on Japanese Patent Application No. 2023-141774 filed in Japan on Aug. 31, 2023, the contents of which are incorporated herein by reference.

### BACKGROUND ART

Patent Literature 1 discloses a work vehicle that causes a cutting edge of a blade to follow a design surface. According to the technique disclosed in Patent Literature 1, the control device specifies the position of the work vehicle using a global navigation satellite system (GNSS), and determines the target height of the blade based on the specified position.

### CITATION LIST

### Patent Literature

Patent Literature 1: WO 2015/083469 A

### SUMMARY OF INVENTION

### Technical Problem

GNSS positioning is performed by calculating a difference between transmission time and reception time of a radio wave transmitted from a GNSS satellite. Therefore, when multipath of radio waves occurs due to terrain or structures, a positioning result may not be accurate.

An object of the present disclosure is to provide a determination system and a determination method capable of determining whether positioning by a GNSS is accurate.

### Solution to Problem

According to one aspect of the present disclosure, a determination system includes an acquisition unit that acquires position data indicating a position of a work vehicle based on a GNSS, and a determination unit that determines accuracy of the position data based on vehicle body data of the work vehicle and the position data.

### Advantageous Effects of Invention

According to the above aspect, as an example, the determination system can determine whether positioning by the GNSS is accurate.

### BRIEF DESCRIPTION OF DRAWINGS

FIG. 1 A side view of a work vehicle according to a first embodiment.

FIG. 2 A diagram illustrating an internal configuration of a cab according to the first embodiment.

FIG. 3 A schematic diagram illustrating a power system of the work vehicle according to the first embodiment.

FIG. 4 A diagram illustrating a configuration of a measurement system and a control device of the work vehicle according to the first embodiment.

FIG. 5 A flowchart illustrating a method for determining accuracy of the GNSS sensor according to the first embodiment.

FIG. 6 A flowchart illustrating a method for determining accuracy of a GNSS sensor according to a second embodiment.

FIG. 7 A diagram illustrating a configuration of a measurement system and a control device of a work vehicle according to a third embodiment.

FIG. 8 A diagram illustrating a configuration of a measurement system and a control device of a work vehicle according to a fourth embodiment.

### DESCRIPTION OF EMBODIMENTS

### First Embodiment

Hereinafter, embodiments will be described in detail with reference to the drawings.

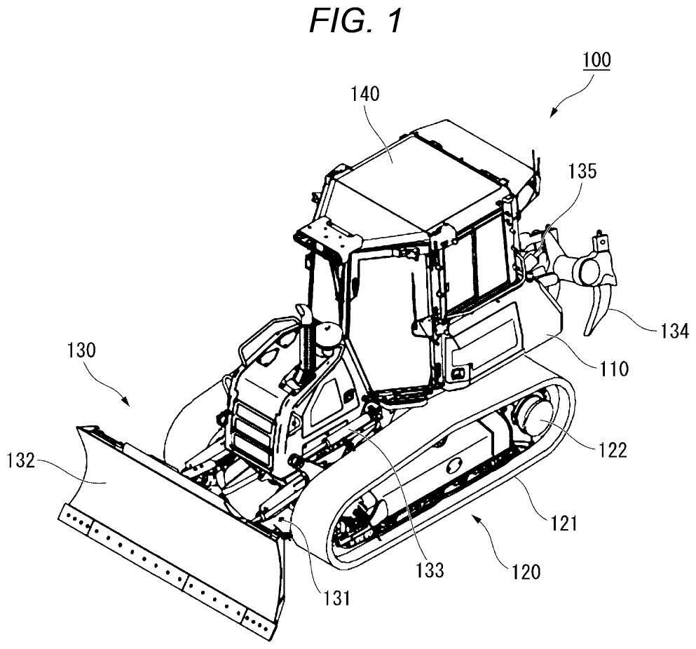

FIG. 1 is a side view of a work vehicle according to a first embodiment.

A work vehicle 100 according to the first embodiment is, for example, a bulldozer. The work vehicle 100 includes a vehicle body 110, a traveling device 120, a work machine 130, and a cab 140.

The traveling device 120 is provided in a lower portion of the vehicle body 110. The traveling device 120 includes pairs of crawlers 121 and sprockets 122. The pair of crawlers 121 is provided on the left and right of the vehicle body 110, respectively. When the crawlers 121 are rotated by driving of the sprockets 122, the work vehicle 100 travels.

The work machine 130 is used for excavation and transportation of an excavation object such as earth and sand. The work machine 130 includes a lift frame 131, a blade 132, a blade lift cylinder 133, a ripper 134, and a ripper lift cylinder 135. The blade 132 is disposed in front of the vehicle body 110. The ripper 134 is disposed behind the vehicle body 110.

The proximal end portion of the lift frame 131 is attached to the side surface of the vehicle body 110 via a pin extending in the vehicle width direction. The distal end portion of the lift frame 131 is attached to the back surface of the blade 132 via a spherical joint. Thus, the blade 132 is supported so as to be movable in the up-down direction with respect to the vehicle body 110. A cutting edge is provided at a lower end portion of the blade 132. The blade lift cylinder 133 is a hydraulic cylinder. The proximal end portion of the blade lift cylinder 133 is attached to a side surface of the vehicle body 110. A distal end portion of the blade lift cylinder 133 is attached to the lift frame 131. When the blade lift cylinder 133 is expanded and contracted by the hydraulic oil, the lift frame 131 and the blade 132 are driven in the raising direction or the lowering direction.

The proximal end portion of the ripper lift cylinder 135 is attached to the vehicle body 110. The distal end portion of the ripper lift cylinder 135 is rotatably attached to the ripper 134. The ripper 134 is driven in the raising direction or the lowering direction by expansion and contraction of the ripper lift cylinder 135 by hydraulic oil.

The cab 140 is a space where an operator boards and operates the work vehicle 100. The cab 140 is provided in an upper portion of the vehicle body 110.

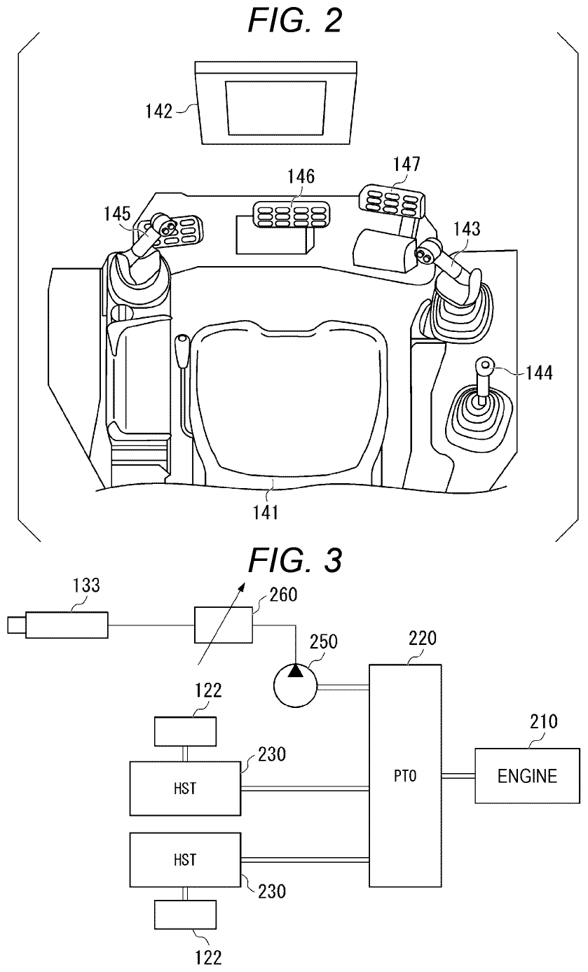

FIG. 2 is a diagram illustrating an internal configuration of the cab 140 according to the first embodiment. Inside the cab 140, a seat 141, a console 142, a blade operation lever 143, a ripper operation lever 144, a travel operation lever 145, a brake pedal 146, and a decelerator pedal 147 are provided. The brake pedal 146 and the decelerator pedal 147 may be configured by one pedal.

An operation panel, instruments, and switches are attached to the console 142. The operator can confirm the state of the work vehicle 100 by visually recognizing the console 142.

The blade operation lever 143 is operated to set the movement amount of the raising operation or the lowering operation of the blade 132. The blade operation lever 143 is tilted forward to receive the lowering operation, and tilted backward to receive the raising operation.

The ripper operation lever 144 is operated to set a movement amount of the raising operation or the lowering operation of the ripper 134. The ripper operation lever 144 is tilted forward to receive the lowering operation, and tilted backward to receive the raising operation. In addition, the blade operation lever 143 may receive a tilt operation for rotating the blade 132 with respect to an axis in the front-rear direction and an angle operation for rotating the blade with respect to an axis in the up-down direction.

The travel operation lever 145 is operated to set the traveling direction of the traveling device 120. The travel operation lever 145 is tilted forward to receive a forward operation, and tilted backward to receive a backward operation. The travel operation lever 145 is tilted leftward to receive a leftward turning operation, and tilted rightward to receive a rightward turning operation. The travel operation lever 145 is provided with a shift button for inputting a speed stage.

The brake pedal 146 is operated to brake the traveling device 120.

The decelerator pedal 147 is operated to reduce the rotation speed of the traveling device 120.

### Power System

FIG. 3 is a schematic diagram illustrating a power system of the work vehicle according to the first embodiment.

The work vehicle 100 includes an engine 210, a power take off (PTO) 220, a pair of hydro static transmission (HST) 230, a hydraulic pump 250, and a proportional control valve 260.

The engine 210 is, for example, a diesel engine.

The PTO 220 transmits a part of the driving force of the engine 210 to the hydraulic pump 250. That is, the PTO 220 distributes the driving force of the engine 210 to the HST 230 and the hydraulic pump 250.

The HST 230 shifts the driving force input to the input shaft and outputs the driving force from the output shaft. The HST 230 includes a hydraulic pump that is driven by the rotation of the input shaft and a hydraulic motor that rotates the output shaft. The HST 230 controls the rotation speed of the output shaft by controlling the discharge flow rate of the hydraulic pump. The input shaft of the HST 230 is connected to the PTO 220, and the output shaft is connected to the sprocket 122. That is, the HST 230 transmits the driving force of the engine 210 distributed by the PTO 220 to the sprocket 122. The output shafts of the pair of HSTs 230 are connected to the left sprocket 122 and the right sprocket 122, respectively.

The hydraulic pump 250 is driven by the driving force from the engine 210. The hydraulic oil discharged from the hydraulic pump 250 is supplied to the blade lift cylinder 133 via the proportional control valve 260.

The proportional control valve 260 controls the flow rate of the hydraulic oil discharged from the hydraulic pump 250. The hydraulic pump 250 may supply the hydraulic oil to other supply destinations such as a steering clutch (not illustrated) in addition to the proportional control valve 260.

### Measurement System

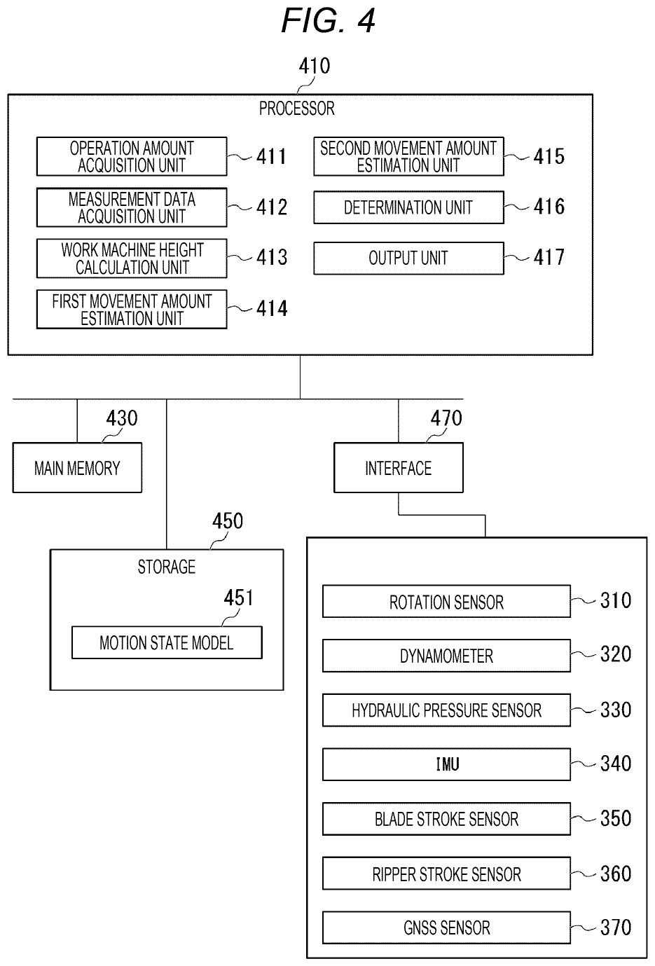

FIG. 4 is a diagram illustrating a configuration of a measurement system and a control device of the work vehicle 100 according to the first embodiment. The work vehicle measurement system 100 acquires vehicle body data representing the state of the work vehicle 100.

The work vehicle 100 includes a rotation sensor 310, a dynamometer 320, a hydraulic pressure sensor 330, an inertial measurement unit (IMU) 340, a blade stroke sensor 350, a ripper stroke sensor 360, and a GNSS sensor 370.

The rotation sensor 310 is provided on each of the left and right sprockets 122. The rotation sensor 310 calculates the rotation speed of the sprocket 122.

The dynamometer 320 is provided in the engine 210. The dynamometer 320 measures power generated by the engine 210.

The hydraulic pressure sensors 330 are provided in the hydraulic motors of the left and right HSTs 230, respectively. The hydraulic pressure sensor 330 measures the hydraulic pressure on the outlet side of the hydraulic motor.

The IMU 340 is provided in the vehicle body 110. The IMU 340 measures the inclination angles in the roll direction and the pitch direction and the angular displacement in the yaw direction of the vehicle body 110. The vehicle body coordinate system is, for example, an orthogonal coordinate system represented by an X axis extending in the front-rear direction of the vehicle body, a Y axis extending in the left-right direction of the vehicle body, and a Z axis extending in the up-down direction of the vehicle body with the origin as the center of the traveling device 120. A rotation direction of the vehicle body 110 about the X axis is defined as a roll direction, a rotation direction of the vehicle body 110 about the Y axis is defined as a pitch direction, and a rotation direction of the vehicle body 110 about the Z axis is defined as a yaw direction.

The blade stroke sensor 350 is provided in the blade lift cylinder 133. The blade stroke sensor 350 measures the stroke amount of the blade lift cylinder 133. The stroke amount measured by the blade stroke sensor 350 can be converted into the position of the cutting edge of the blade 132 in the vehicle body coordinate system. Specifically, the rotation angle of the lift frame 131 is calculated based on the stroke amount of the blade lift cylinder 133. Since the shapes of the lift frame 131 and the blade 132 are known, the position of the cutting edge of the blade 132 can be identified from the rotation angle of the lift frame 131. The work vehicle 100 according to another embodiment may detect the rotation angle of the lift frame 131 with another sensor such as an encoder.

The ripper stroke sensor 360 is provided in the ripper lift cylinder 135. The ripper stroke sensor 360 measures a stroke amount of the ripper lift cylinder 135. The stroke amount measured by the ripper stroke sensor 360 can be converted into the position of the cutting edge of the ripper in the vehicle body coordinate system. The work vehicle 100 according to another embodiment may detect the rotation angle of the ripper 134 with another sensor such as an encoder. The work vehicle 100 according to another embodiment may not include a sensor that detects the state of the ripper 134. In this case, for example, a control device 400 may determine whether the ripper 134 is raised or lowered based on an operation amount of the ripper operation lever 144.

The GNSS sensor 370 is provided in the vehicle body 110. The GNSS sensor 370 measures the position and azimuth of the vehicle body 110 in the global coordinate system based on a signal from a GNSS satellite. The GNSS sensor 370 may perform real time kinematic (RTK) positioning. In this case, the GNSS sensor 370 communicates with a fixed station provided at the work site and corrects the measurement data. The GNSS sensor 370 outputs, as measurement data, accuracy information indicating positioning accuracy in addition to the position and azimuth. The accuracy information may indicate, for example, success or failure of correction by the fixed station, the number of satellites that can be measured, and the like. The accuracy information may be a numerical value indicating the positioning accuracy. The GNSS sensor 370 is an example of a position estimation unit that estimates the position and posture of the work vehicle 100 based on the measurement data.

### Control Device

The work vehicle 100 includes a control device 400 for controlling the work vehicle 100.

The control device 400 outputs a control signal to the fuel injection device of the engine 210, the HST 230, and the proportional control valve 260 according to the operation amount of each operation device (the console 142, the blade operation lever 143, the ripper operation lever 144, the travel operation lever 145, the brake pedal 146, and the decelerator pedal 147) in the cab 140. In addition, the control device 400 measures the position of the work vehicle 100 based on the measurement data of the measurement system and displays the position on the console 142. The control device 400 may autonomously control the power system based on the position of the work vehicle 100 measured based on the measurement data of the measurement system.

The control device 400 is a computer including a processor 410, a main memory 430, a storage 450, and an interface 470.

The storage 450 is a non-transitory tangible storage medium. Examples of the storage 450 include a magnetic disk, a magneto-optical disk, and a semiconductor memory. The storage 450 may be an internal medium directly connected to the bus of the control device 400 or an external medium connected to the control device 400 via the interface 470 or a communication line. The storage 450 stores a program for controlling the work vehicle 100. In addition, the storage 450 stores a motion state model 451 which is a machine learning model which is learned in advance for calculating a speed and an angular velocity of the vehicle body 110. The motion state model 451 will be described later.

In another embodiment, the control device 400 may include a custom large scale integrated circuit (LSI) such as a programmable logic device (PLD) in addition to or instead of the above configuration. Examples of the PLD include a programmable array logic (PAL), a generic array logic (GAL), a complex programmable logic device (CPLD), and a field programmable gate array (FPGA). In this case, some or all of the functions implemented by the processor 410 may be implemented by the integrated circuit.

The processor 410 includes an operation amount acquisition unit 411, a measurement data acquisition unit 412, a work machine height calculation unit 413, a first movement amount estimation unit 414, a second movement amount estimation unit 415, a determination unit 416, and an output unit 417 by executing the program. The measurement data by the measurement system is input to the processor 410 via the interface 470.

The operation amount acquisition unit 411 acquires the operation amount from the blade operation lever 143, the ripper operation lever 144, the travel operation lever 145, the brake pedal 146, and the decelerator pedal 147.

The measurement data acquisition unit 412 acquires measurement data from each of the rotation sensor 310, the dynamometer 320, the hydraulic pressure sensor 330, the IMU 340, the blade stroke sensor 350, the ripper stroke sensor 360, and the GNSS sensor 370. That is, the measurement data acquisition unit 412 acquires measurement data of the yaw angle of the vehicle body 110, the roll angle of the vehicle body 110, the pitch angle of the vehicle body 110, the rotation speeds of the left and right sprockets 122, the stroke amount of the blade lift cylinder 133, and the stroke amount of the ripper lift cylinder 135.

The work machine height calculation unit 413 calculates the height of the cutting edge of the blade 132 with respect to the vehicle body based on the measurement data of the stroke amount of the blade lift cylinder 133 acquired by the measurement data acquisition unit 412. That is, the work machine height calculation unit 413 calculates the height of the cutting edge of the blade 132 in the vehicle body coordinate system from the dimension information of the vehicle body 110 stored in advance and the measurement data of the stroke amount of the blade lift cylinder 133. The work machine height calculation unit 413 calculates the height of the cutting edge of the ripper 134 with respect to the vehicle body based on the measurement data of the stroke amount of the ripper lift cylinder 135 acquired by the measurement data acquisition unit 412.

The first movement amount estimation unit 414 inputs the operation amount acquired by the measurement data acquisition unit 412 and the measurement data acquired by the measurement data acquisition unit 412 to the motion state model 451 to estimate the speed and the angular velocity of the work vehicle 100.

The second movement amount estimation unit 415 estimates the speed and the angular velocity of the work vehicle 100 based on the measurement data of the GNSS sensor 370 acquired by the measurement data acquisition unit 412. Specifically, the second movement amount estimation unit 415 calculates the turning angular velocity of the work vehicle 100 based on the difference between the azimuth indicated by the latest measurement data of the GNSS sensor 370 acquired by the measurement data acquisition unit 412 and the azimuth indicated by the previous measurement data. The second movement amount estimation unit 415 calculates the speed of the work vehicle 100 in the global coordinate system based on the difference between the three-dimensional position indicated by the latest measurement data of the GNSS sensor 370 acquired by the measurement data acquisition unit 412 and the three-dimensional position indicated by the previous measurement data, and converts the speed in the global coordinate system into the speed in each of the X axis, Y axis, and Z axis directions based on the work vehicle 100 based on the azimuth indicated by the latest measurement data of the GNSS sensor 370.

The determination unit 416 determines whether the measurement data of the GNSS sensor 370 is accurate based on the speed and angular velocity estimated by the first movement amount estimation unit 414 and the speed and angular velocity estimated by the second movement amount estimation unit 415. Specifically, the determination unit 416 determines that the measurement data of the GNSS sensor 370 is accurate when all of the difference between the speed in the X-axis direction estimated by the first movement amount estimation unit 414 and the speed in the X-axis direction estimated by the second movement amount estimation unit 415, the difference between the speed in the Y-axis direction estimated by the first movement amount estimation unit 414 and the speed in the Y-axis direction estimated by the second movement amount estimation unit 415, the difference between the speed in the Z-axis direction estimated by the first movement amount estimation unit 414 and the speed in the Z-axis direction estimated by the second movement amount estimation unit 415, and the difference between the turning angular velocity estimated by the first movement amount estimation unit 414 and the turning angular velocity estimated by the second movement amount estimation unit 415 are smaller than a predetermined threshold.

The output unit 417 outputs the position and azimuth indicated by the measurement data of the GNSS sensor 370 to the console 142. When the determination unit 416 determines that the measurement data of the GNSS sensor 370 is not accurate, the output unit 417 outputs a warning indicating that the GNSS sensor 370 may be inaccurate.

### Motion State Model

The motion state model 451 according to the first embodiment receives the operation amount of the travel operation lever 145, the rotation speeds of the left and right sprockets 122, the measurement data of the IMU 340, the measurement data of the pressure of the HST 230 (hydraulic motor), the measurement data of the dynamometer 320, the speed stage, the height of the blade 132, and the height of the ripper 134, and outputs the speed in the X-axis direction, the speed in the Y-axis direction, the speed in the Z-axis direction, the angular velocity (roll angular velocity) around the X axis, the angular velocity (pitch angular velocity) around the Y axis, and the angular velocity (turning angular velocity) around the Z axis of the vehicle body coordinate system. The motion state model 451 is a machine learning model such as a neural network. The motion state model 451 may include a CNN or an RNN. In particular, when the motion state model 451 is constituted by a regression-type neural network such as a long short term memory (LSTM) or a transformer, the motion state of the work vehicle 100 can be appropriately estimated according to a change in state with time. The motion state model 451 according to another embodiment may not necessarily use all of the operation amount of the travel operation lever 145, the rotation speeds of the left and right sprockets 122, the measurement data of the IMU 340, the measurement data of the pressure of the HST 230 (hydraulic motor), the measurement data of the dynamometer 320, the speed stage, the height of the blade 132, and the height of the ripper 134 in order to estimate the motion state. As described later, the motion state model 451 may calculate the movement amount of the work vehicle 100 using at least one of the height of the blade 132, the height of the ripper 134, the operation amount of the travel operation lever 145, the speed stage, the output of the engine 210, and the pressure of the hydraulic motor of the HST 230.

The motion state model 451 is learned using a learning data set including a combination of the following input samples and output samples. The input samples are the operation amount of the travel operation lever 145, the rotation speeds of the left and right sprockets 122, the measurement data of the IMU 340, the pressure of the HST 230, the power of the engine 210, the speed stage, the height of the blade 132, and the height of the ripper 134. The output samples are a speed in the X-axis direction, a speed in the Y-axis direction, a speed in the Z-axis direction, an angular velocity around the X axis, an angular velocity around the Y axis, an angular velocity around the Z axis, a roll angle, and a pitch angle of the vehicle body coordinate system. The speed of the work vehicle 100 related to the output sample may be a value calculated from measurement data of the GNSS sensor 370. The angular velocity and the attitude angle of the work vehicle 100 according to the output sample may be values specified from measurement data of the IMU 340.

The rotation speed of the sprocket 122 has a strong correlation with the movement amount of the work vehicle 100. In general dead reckoning, a movement amount is often calculated from a rotation speed. On the other hand, when a slip occurs in the crawler 121 or the like, the movement amount calculated from the rotation speed of the sprocket 122 may be different from the actual movement amount.

The measurement data of the IMU 340 has a strong correlation with the angular velocity and the inclination angle of the work vehicle 100. In general dead reckoning, the traveling direction of the vehicle body is often calculated from the angular velocity and acceleration of the IMU 340. On the other hand, when the work vehicle 100 is traveling while working, the vehicle body 110 vibrates, and thus, there is a possibility that noise due to vibration is added to the measurement data of the IMU 340.

The height of the blade 132 and the height of the ripper 134 are related to the reaction force that the work vehicle 100 receives from the work target. As the blade 132 and the ripper 134 are lower, there is a higher possibility that the blade 132 and the ripper 134 are in contact with a work target and are working. When the work vehicle 100 is working, the work vehicle 100 receives a reaction force from the work target. The height of the blade 132 and the height of the ripper 134 are examples of values related to the state of the work machine 130.

The combination of the operation amount of the travel operation lever 145 and the rotation speed of the sprocket 122 is related to the reaction force that the work vehicle 100 receives from the work target. In addition, the measurement data related to the power of the traveling device 120 such as the output of the engine 210 and the pressure of the hydraulic motor of the HST 230 is related to the reaction force that the work vehicle 100 receives from the work target and the slip generated by the reaction force.

The speed stage relates to a slip generated by a reaction force that the work vehicle 100 receives from the work target. The maximum speed and torque of the work vehicle 100 are determined by the speed stage. Therefore, as the speed stage is lower, slip is less likely to occur, and as the speed stage is higher, slip is more likely to occur.

When the work vehicle 100 receives a strong reaction force from the work target, the rotation speed of the sprocket 122 is lowered by the static frictional force applied to the traveling device 120. As the rotation speed of the sprocket 122 decreases, the rotation speed of the hydraulic motor of the HST 230 that rotates the sprocket 122 is lowered. When the rotation speed of the hydraulic motor of the HST 230 is lowered, the pressure between the hydraulic pump of the HST 230 and the hydraulic motor increases. As the pressure of the HST 230 increases, the rotation speed of the input shaft of the HST 230 is lowered, and the rotation speed of the engine 210 decreases.

Thereafter, when the slip occurs due to the reaction force from the work target, the frictional force applied to the traveling device 120 changes from the static frictional force to the dynamic frictional force, so that the rotation speeds of the hydraulic motor of the HST 230 and the sprocket 122 increase. When the rotation speed of the hydraulic motor of the HST 230 increases, the pressure between the hydraulic pump of the HST 230 and the hydraulic motor decreases. As the pressure of the HST 230 decreases, the rotation speed of the input shaft of the HST 230 increases, and the rotation speed of the engine 210 increases. Therefore, when the movement amount of the work vehicle 100 is directly calculated from the rotation speed of the sprocket 122, an error in the movement amount becomes large. On the other hand, in the motion state model 451, the movement amount of the work vehicle 100 is calculated using at least one of the height of the blade 132, the height of the ripper 134, the operation amount of the travel operation lever 145, the speed stage, the output of the engine 210, and the pressure of the hydraulic motor of the HST 230, so that the movement amount can be calculated while suppressing the influence of the slip.

When the work vehicle 100 receives a reaction force from a work target, the reaction force may cause the traveling device 120 to float. For example, when the traveling device 120 moves forward while the blade 132 receives the reaction force, the vehicle body 110 may move forward while the front of the traveling device 120 floats. In this case, since the traveling direction of the work vehicle 100 does not coincide with the inclination angle of the vehicle body 110 measured by the IMU 340, a shift occurs in the moving direction in general dead reckoning. On the other hand, the motion state model 451 can estimate the traveling direction of the work vehicle 100 even if floating occurs in the traveling device 120 by calculating the movement amount of the work vehicle 100 using at least one of the height of the blade 132, the height of the ripper 134, the operation amount of the travel operation lever 145, the output of the engine 210, and the pressure of the hydraulic motor of the HST 230. Note that the inclination angle output by the motion state model 451 may be not the inclination angle of the vehicle body 110 but the inclination angle in the traveling direction of the work vehicle 100.

### Method for Determining Accuracy of GNSS Sensor 370

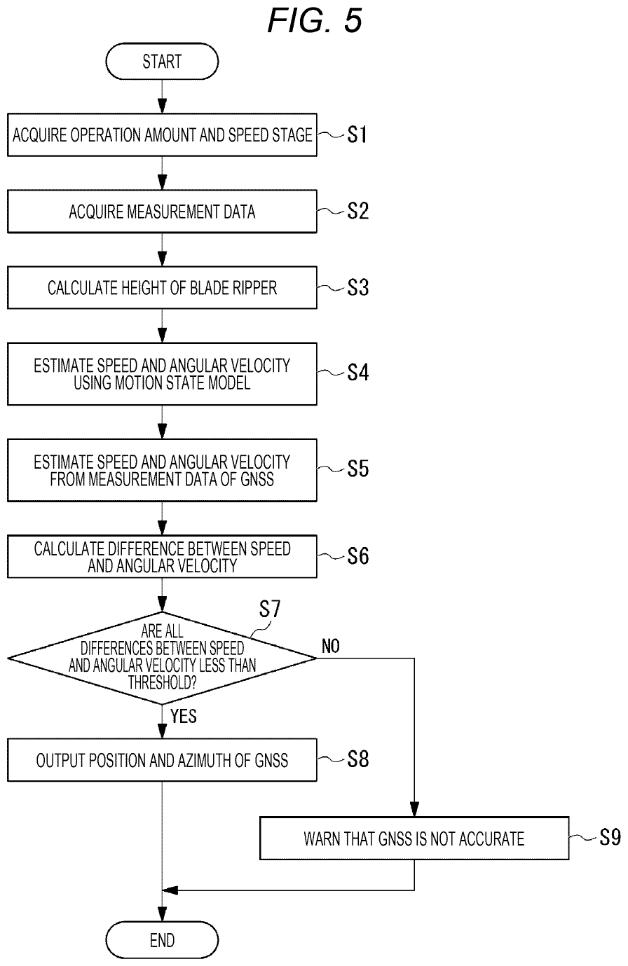

Next, a method for determining the accuracy of the GNSS sensor 370 according to the first embodiment will be described. FIG. 5 is a flowchart illustrating a method for determining the accuracy of the GNSS sensor 370 according to the first embodiment. The control device 400 repeatedly executes the flowchart illustrated in FIG. 5 while the work vehicle 100 is in operation.

The operation amount acquisition unit 411 acquires the operation amount and the speed stage of the travel operation lever 145 (step S1). The measurement data acquisition unit 412 acquires measurement data from each of the rotation sensor 310, the dynamometer 320, the hydraulic pressure sensor 330, the IMU 340, the blade stroke sensor 350, the ripper stroke sensor 360, and the GNSS sensor 370 (step S2). Next, the work machine height calculation unit 413 calculates the height of the cutting edges of the blade 132 and the ripper 134 based on the measurement data of the stroke amount of the blade lift cylinder 133 and the stroke amount of the ripper lift cylinder 135 acquired by the measurement data acquisition unit 412 (step S3).

The first movement amount estimation unit 414 inputs, to the motion state model 451, the operation amount and the speed stage of the travel operation lever 145 acquired in step S1, the rotation speeds of the left and right sprockets 122 acquired in step S2, the measurement data of the IMU 340, the measurement data of the pressure of the HST 230 and the measurement data of the dynamometer 320, and the height of the blade 132 and the height of the ripper 134 calculated in step S3. As a result, the first movement amount estimation unit 414 estimates the speed in the X-axis direction, the speed in the Y-axis direction, the speed in the Z-axis direction, and the turning angular velocity of the work vehicle 100 (step S4).

The second movement amount estimation unit 415 estimates the speed in the X-axis direction, the speed in the Y-axis direction, the speed in the Z-axis direction, and the turning angular velocity of the work vehicle 100 based on the measurement data of the GNSS sensor 370 acquired by the measurement data acquisition unit 412 (step S5).

The determination unit 416 calculates differences between the speed in the X-axis direction, the speed in the Y-axis direction, the speed in the Z-axis direction, and the turning angular velocity estimated by the first movement amount estimation unit 414 and the second movement amount estimation unit 415 (step S6). The determination unit 416 determines whether all the calculated differences are smaller than a predetermined threshold (step S7). When all the differences are smaller than the threshold (step S7: YES), the determination unit 416 determines that the measurement data of the GNSS sensor 370 is accurate. The output unit 417 outputs the position and azimuth indicated by the measurement data of the GNSS sensor 370 acquired in step S2 to the console 142 (step S8).

When the at least one difference is equal to or larger than the threshold (step S7: NO), the determination unit 416 determines that the measurement data of the GNSS sensor 370 is not accurate. The output unit 417 outputs a warning indicating that the measurement data of the GNSS sensor 370 is not accurate to the console 142 (step S9). The output unit 417 may output the position and azimuth indicated by the measurement data of the GNSS sensor 370 acquired in step S2 to the console 142, or may output only the warning.

### Operation and Effect

As described above, the control device 400 according to the first embodiment includes the measurement data acquisition unit 412, the first movement amount estimation unit 414, and the determination unit 416. The measurement data acquisition unit 412 acquires position data indicating the position of the work vehicle 100 based on the GNSS. The first movement amount estimation unit 414 estimates a value related to the movement amount of the work vehicle 100 based on the vehicle body data of the work vehicle 100. The determination unit 416 determines the accuracy of the position data based on the value related to the movement amount and the position data. As a result, in the control device 400 according to the first embodiment, when the accuracy of the measurement data of the GNSS sensor 370 decreases due to the influence of multipath or the like, the position indicated by the measurement data greatly deviates from the past position, and the deviation from the movement amount calculated from the vehicle body data increases. Therefore, the control device 400 according to the first embodiment can determine the accuracy of the measurement data of the GNSS sensor 370.

In addition, the control device 400 according to the first embodiment estimates the movement amount using a value related to the power of the traveling device 120 of the work vehicle 100 and a value related to the state of the work machine 130. Since both the power of the traveling device 120 and the state of the work machine 130 are related to a slip and floating of the traveling device 120, the movement amount of the work vehicle 100 can be accurately estimated using these. On the other hand, the control device 400 according to another embodiment may estimate the movement amount by the dead reckoning from the rotation speed of the sprocket 122, for example, without using the power of the traveling device 120 and the state of the work machine 130. For example, in an environment in which the influence of a slip or floating of the work vehicle 100 is small, the accuracy of the measurement data of the GNSS sensor 370 can be determined even using the movement amount estimated by the dead reckoning.. In addition, the control device 400 according to another embodiment may estimate the movement amount of the work vehicle 100 using one of the power of the traveling device 120 and the state of the work machine 130.

### Second Embodiment

The control device 400 according to the second embodiment outputs the estimation accuracy of each value in addition to the speed and the angular velocity as the estimation result of the first movement amount estimation unit 414. The first movement amount estimation unit 414 outputs a variance-covariance matrix having a dimension of the number of items for estimating the estimation accuracy. For example, the first movement amount estimation unit 414 can calculate the estimation accuracy by obtaining the variance of the estimation results from the results of inference by the plurality of motion state models 451. For example, the first movement amount estimation unit 414 may output the average value of the speed, the angular velocity, and the inclination angle and the standard deviation as the estimation accuracy using the motion state model 451 learned to output the average value and the standard deviation of the Gaussian distribution as the estimation result.

### Method for Determining Accuracy of GNSS Sensor 370

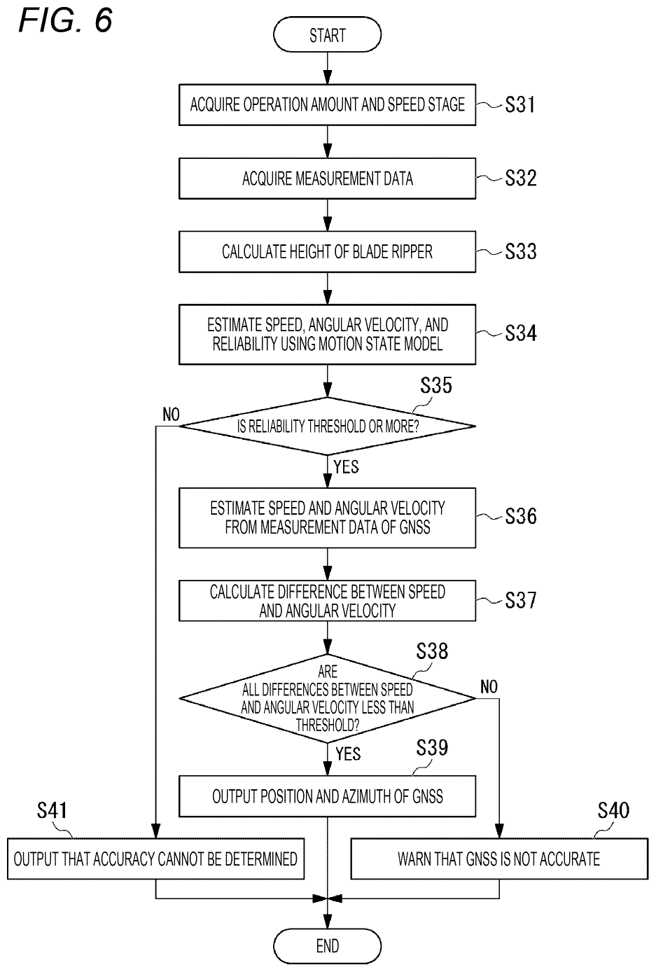

Next, a method for determining the accuracy of the GNSS sensor 370 according to the second embodiment will be described. FIG. 6 is a flowchart illustrating a method for determining accuracy of the GNSS sensor 370 according to the second embodiment. The control device 400 repeatedly executes the flowchart illustrated in FIG. 6 while the work vehicle 100 is in operation.

The operation amount acquisition unit 411 acquires the operation amount and the speed stage of the travel operation lever 145 (step S31). The measurement data acquisition unit 412 acquires measurement data from each of the rotation sensor 310, the dynamometer 320, the hydraulic pressure sensor 330, the IMU 340, the blade stroke sensor 350, the ripper stroke sensor 360, and the GNSS sensor 370 (step S32). Next, the work machine height calculation unit 413 calculates the height of the cutting edges of the blade 132 and the ripper 134 based on the measurement data of the stroke amount of the blade lift cylinder 133 and the stroke amount of the ripper lift cylinder 135 acquired by the measurement data acquisition unit 412 (step S33).

The first movement amount estimation unit 414 inputs, to the motion state model 451, the operation amount and the speed stage of the travel operation lever 145 acquired in step S31, the rotation speeds of the left and right sprockets 122 acquired in step S32, the measurement data of the IMU 340, the measurement data of the pressure of the HST 230 and the measurement data of the dynamometer 320, and the height of the blade 132 and the height of the ripper 134 calculated in step S33. As a result, the first movement amount estimation unit 414 estimates the speed in the X-axis direction, the speed in the Y-axis direction, the speed in the Z-axis direction, and the turning angular velocity of the work vehicle 100, and outputs a variance-covariance matrix indicating the reliability (step S34).

The determination unit 416 determines whether the reliability represented by the variance-covariance matrix is greater than or equal to a predetermined threshold (step S35). For example, the determination unit 416 may regard a reciprocal of an average value of variances that are diagonal components of the variance-covariance matrix as the reliability.

When the reliability is equal to or more than the threshold (step S35: YES), the second movement amount estimation unit 415 estimates the speed in the X-axis direction, the speed in the Y-axis direction, the speed in the Z-axis direction, and the turning angular velocity of the work vehicle 100 based on the measurement data of the GNSS sensor 370 acquired by the measurement data acquisition unit 412 (step S36).

The determination unit 416 calculates differences between the speed in the X-axis direction, the speed in the Y-axis direction, the speed in the Z-axis direction, and the turning angular velocity estimated by the first movement amount estimation unit 414 and the second movement amount estimation unit 415 (step S37). The determination unit 416 determines whether all the calculated differences are smaller than a predetermined threshold (step S38). When all the differences are smaller than the threshold (step S38: YES), the determination unit 416 determines that the measurement data of the GNSS sensor 370 is accurate. The output unit 417 outputs the position and azimuth indicated by the measurement data of the GNSS sensor 370 acquired in step S32 to the console 142 (step S39).

When the at least one difference is equal to or larger than the threshold (step S38: NO), the determination unit 416 determines that the measurement data of the GNSS sensor 370 is not accurate. The output unit 417 outputs a warning indicating that the measurement data of the GNSS sensor 370 is not accurate to the console 142 (step S40). The output unit 417 may output the position and azimuth indicated by the measurement data of the GNSS sensor 370 acquired in step S2 to the console 142, or may output only the warning.

When the reliability is less than the threshold (step S35: NO), the output unit 417 outputs a message indicating that the accuracy of the measurement data of the GNSS sensor 370 cannot be determined to the console 142 (step S41). The output unit 417 may output the position and azimuth indicated by the measurement data of the GNSS sensor 370 acquired in step S2 to the console 142, or may output only a message.

### Third Embodiment

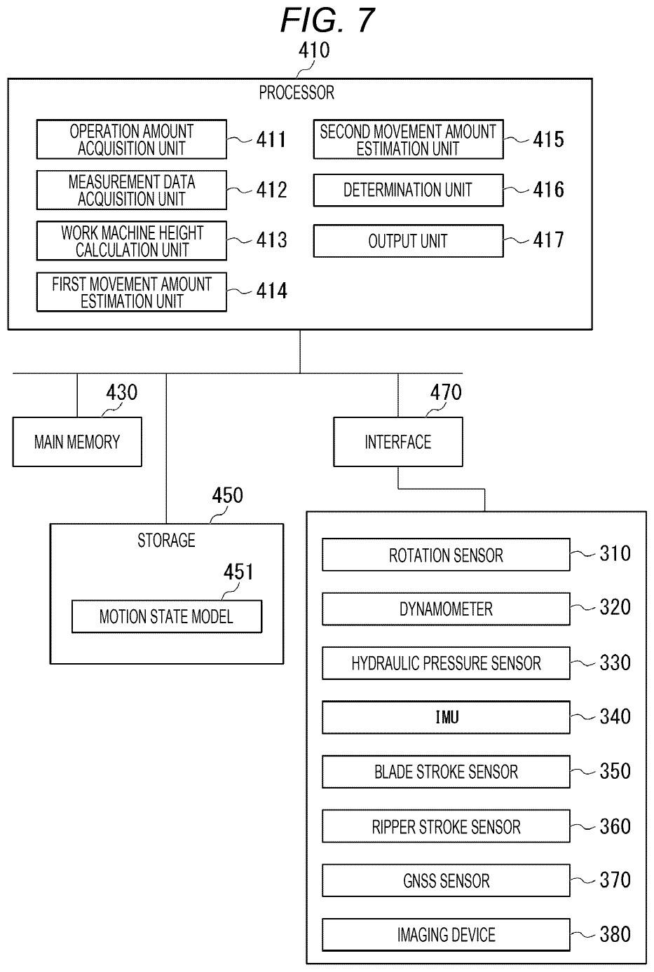

FIG. 7 is a diagram illustrating a configuration of a measurement system and a control device of a work vehicle 100 according to a third embodiment. The work vehicle 100 according to the third embodiment further includes an imaging device 380 that images a work target of the work vehicle 100 as a measurement system. Examples of the imaging device 380 include a camera, light detection and ranging (LiDAR), a laser scanner, and the like. The measurement data of the imaging device 380 is a two-dimensional image or a distance image.

The first movement amount estimation unit 414 according to the third embodiment inputs the measurement data of the imaging device 380 to the motion state model 451 to estimate the speed, acceleration, and inclination angle of the work vehicle 100. In the motion state model 451 according to the third embodiment, the measurement data of the imaging device 380 is further input in addition to the operation amount of the travel operation lever 145, the rotation speeds of the left and right sprockets 122, the measurement data of the IMU 340, the measurement data of the pressure of the HST 230 (hydraulic motor), the measurement data of the dynamometer 320, the speed stage, the height of the blade 132, and the height of the ripper 134. Instead of the measurement data itself of the imaging device 380, feature amount data extracted from the measurement data may be input to the motion state model 451. The feature amount of the measurement data of the imaging device 380 may be obtained from, for example, the intermediate layer of the convolutional autoencoder.

The measurement data of the imaging device 380 relates to a slip generated by a reaction force that the work vehicle 100 receives from the work target. For example, the slipperiness of the work vehicle 100 varies depending on the work target and the nature of the ground. When the ground is muddy, slip of the work vehicle 100 is likely to occur. Therefore, there is a possibility that the nature of the work target and the ground appears in the image that is the measurement data of the imaging device 380 and the feature amount thereof.

In addition, the measurement data of the imaging device 380 has a correlation with the movement amount and the angular velocity of the work vehicle 100 in a case where the motion state model 451 includes a regression-type neural network. As the work vehicle 100 travels, a scene appearing in an image that is measurement data of the imaging device 380 changes. The magnitude of temporal change in the scenery varies depending on the movement amount and the angular velocity of the work vehicle 100. In addition, in a case where the imaging device 380 is LiDAR, a distance appears in the measurement data. The change in distance is correlated with the movement amount of the work vehicle 100.

Therefore, the first movement amount estimation unit 414 according to the third embodiment can improve the reliability by estimating the position and azimuth of the work vehicle 100 using the measurement data of the imaging device 380.

### Fourth Embodiment

The work vehicle 100 according to the first embodiment determines the accuracy of the GNSS sensor 370 based on the difference between the speed and the acceleration. On the other hand, the control device 400 according to the fourth embodiment estimates the position and azimuth of the work vehicle 100 from the estimated movement amount, and determines the accuracy of the GNSS sensor 370 based on the difference between the position and azimuth.

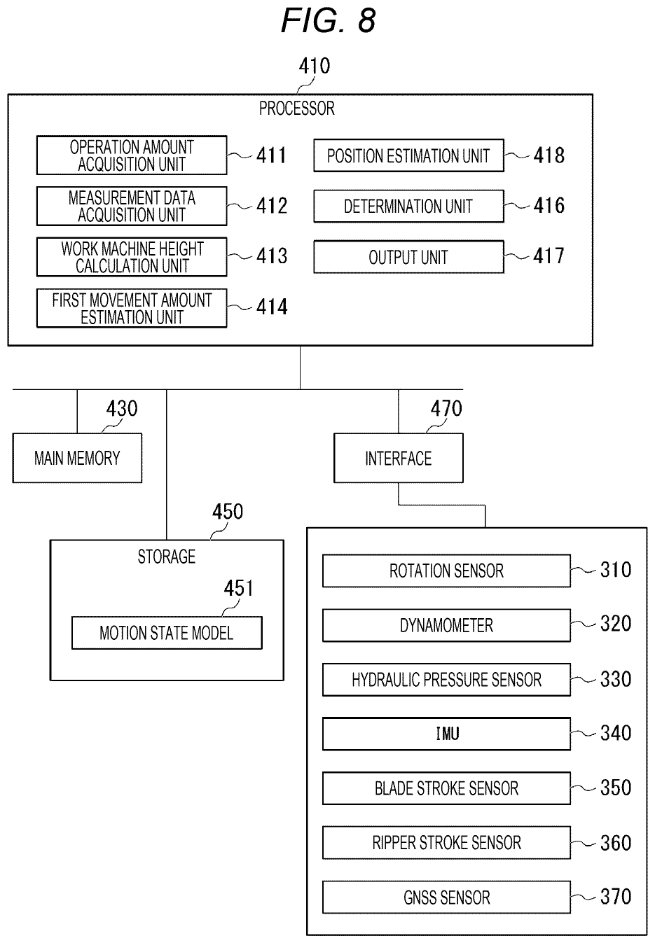

FIG. 8 is a diagram illustrating a configuration of a measurement system and a control device of a work vehicle 100 according to a fourth embodiment. The control device 400 according to the fourth embodiment includes a position estimation unit 418 instead of the second movement amount estimation unit 415 according to the first embodiment.

The position estimation unit 418 estimates the current position, azimuth, and inclination angle of the work vehicle 100 based on the previous estimation result of the position, azimuth, and inclination angle of the work vehicle 100 and the speed, angular velocity, and inclination angle of the work vehicle 100 estimated by the first movement amount estimation unit 414. The position estimation unit 418 may be realized by, for example, a Bayesian filter. That is, the position estimation unit 418 may be a Bayesian filter that estimates the position, the azimuth, and the inclination angle at the time t using the estimation result of the position and the inclination angle at the time t−1 as a “state (posteriori belief)”, the speed and the angular velocity of the work vehicle 100 at the time t estimated by the first movement amount estimation unit 414 as a “control value”, and the inclination angle of the work vehicle 100 at the time t estimated by the first movement amount estimation unit 414 as an “observation value”.

The determination unit 416 according to the fourth embodiment determines the accuracy of the GNSS sensor 370 based on a difference between the position and azimuth indicated by the measurement data of the GNSS sensor 370 and the position and azimuth estimated by the position estimation unit 418.

### Fifth Embodiment

The control device 400 according to the above-described embodiment estimates the movement amount of the work vehicle 100 and determines the accuracy of the GNSS sensor 370 based on the movement amount. On the other hand, the control device 400 according to the fifth embodiment determines the accuracy of the GNSS sensor 370 without estimating the movement amount. Therefore, the control device 400 according to the fifth embodiment does not need to include the first movement amount estimation unit 414 and the second movement amount estimation unit 415.

The storage 450 according to the fifth embodiment stores a GNSS determination model instead of the motion state model 451. The GNSS determination model receives the operation amount of the travel operation lever 145, the rotation speeds of the left and right sprockets 122, the measurement data of the IMU 340, the measurement data of the pressure of the HST 230 (hydraulic motor), the measurement data of the dynamometer 320, the speed stage, the height of the blade 132 and the height of the ripper 134, and the measurement value of the GNSS sensor 370, and outputs a value indicating the accuracy of the GNSS sensor 370. The GNSS determination model is a machine learning model such as a neural network. The GNSS determination model may include a CNN or an RNN. In particular, when the GNSS determination model is constituted by a neural network that refers to past steps such as a long short term memory (LSTM) and a transformer, the accuracy of the GNSS sensor 370 can be appropriately estimated according to the slip state of the work vehicle 100 according to a change in state with time. Note that the transformer is a neural network capable of referring to information of past steps by attention.

The GNSS determination model is learned using a learning data set including a combination of the following input samples and output samples. The input samples are the operation amount of the travel operation lever 145, the rotation speeds of the left and right sprockets 122, the measurement data of the IMU 340, the pressure of the HST 230, the power of the engine 210, the speed stage, the height of the blade 132, the height of the ripper 134, and the measurement value of the GNSS sensor 370. The output sample is a value indicating the accuracy of the GNSS sensor 370. The value indicating the accuracy of the GNSS sensor 370 may be a value calculated from the calculation result of the motion state model 451 according to the above-described embodiment and the measurement data of the GNSS sensor 370. For example, the ratio between the speed indicated by the calculation result of the motion state model 451 and the speed calculated from the measurement data of the GNSS sensor 370 can be set as a value indicating the accuracy of the GNSS sensor 370. In addition, the value indicating the accuracy of the GNSS sensor 370 may be a value calculated by comparing the position measured by the total station with the position indicated by the measurement data of the GNSS sensor 370.

### Another Embodiment

Although the embodiments have been described in detail with reference to the drawings, the specific configuration is not limited to the above-described configuration, and various design changes and the like can be made. That is, in another embodiment, the order of the above-described processing may be appropriately changed. Furthermore, some processing may be executed in parallel.

The control device 400 according to the above-described embodiment may be configured by a single computer, or the configuration of the control device 400 may be divided into a plurality of computers and the plurality of computers may function as the control device 400 in cooperation with each other. At this time, some computers constituting the control device 400 may be mounted inside the work vehicle 100, and other computers may be provided outside the work vehicle 100.

The work vehicle 100 according to the above-described embodiment includes the HST 230 as a power transmission device, but the work vehicle is not limited thereto. For example, the power transmission device of the work vehicle 100 according to another embodiment may be a hydromechanical continuously variable transmission (HMT) that performs shift control by a combination of the HST 230 and a planetary gear mechanism. The power transmission device of the work vehicle 100 according to another embodiment may be a clutch. Even when the power transmission device is an HMT or a clutch, the output of the engine 210 is related to the reaction force that the work vehicle 100 receives from the work target and the slip generated by the reaction force. This is because the influence of the reaction force appears in the engine 210 when the engine 210 and the power transmission device are connected. Therefore, by inputting the measurement data of the dynamometer 320 to the motion state model 451, the control device 400 can estimate the movement amount of the work vehicle 100 while suppressing the influence of the reaction force from the work target.

Furthermore, for example, the power transmission device of the work vehicle 100 according to another embodiment may be an electric mechanical transmission (EMT) including a generator and an electric motor instead of the hydraulic pump and the hydraulic motor. In this case, the control device 400 may estimate the movement amount of the work vehicle 100 by inputting the measurement data of the current value of the electric motor to the motion state model 451. The measurement data of the current value of the electric motor is an example of a value related to the power of the traveling body.

In addition, the determination unit 416 of the control device 400 according to the above-described embodiment determines the accuracy of the GNSS sensor 370 by comparing the speed and the angular velocity of the work vehicle 100 calculated by the motion state model 451 with the speed and the angular velocity calculated from the measurement data of the GNSS sensor 370, but the present disclosure is not limited thereto. For example, the determination unit 416 according to another embodiment may determine the accuracy of the GNSS sensor 370 by comparing the position indicated by the measurement data of the GNSS sensor with the position of the work vehicle 100 obtained from the calculation result of the motion state model 451.

The work vehicle 100 according to the above-described embodiment is a bulldozer, but the work vehicle 100 according to another embodiment is not limited thereto. For example, the work vehicle 100 according to another embodiment may be a wheel loader, a motor grader, or the like. The work vehicle 100 according to another embodiment may be an electric vehicle including a battery and an electric motor instead of the engine 210.

In addition, the control device 400 according to the above-described embodiment causes the console 142 to display the estimated position, azimuth, and inclination angle of the work vehicle 100, but the control device is not limited thereto. For example, the control device 400 according to another embodiment may execute autonomous control for controlling the drive system based on the estimated position, azimuth, and inclination angle of the work vehicle 100.

### Industrial Applicability

According to the present disclosure, as an example, the determination system can determine whether positioning by the GNSS is accurate.

### Reference Signs List

100 work vehicle
110 vehicle body
120 traveling device
121 crawler
122 sprocket
123 traveling motor
130 work machine
131 lift frame
132 blade
133 blade lift cylinder
134 ripper
135 ripper lift cylinder
140 cab
141 seat
142 console
143 blade operation lever
144 ripper operation lever
145 travel operation lever
146 brake pedal
147 decelerator pedal
210 engine
220 PTO
230 HST
250 hydraulic pump
260 proportional control valve
310 rotation sensor
320 dynamometer
330 hydraulic pressure sensor
340 IMU
350 blade stroke sensor
360 ripper stroke sensor
370 GNSS sensor
380 imaging device
400 control device
410 processor
411 operation amount acquisition unit
412 measurement data acquisition unit
413 work machine height calculation unit
414 first movement amount estimation unit
415 second movement amount estimation unit
416 determination unit
417 output unit
418 position estimation unit
430 main memory
450 storage
451 motion state model
470 interface

1. A determination system comprising:
an acquisition unit that acquires position data indicating a position of a work vehicle based on a global navigation satellite system (GNSS); and
a determination unit that determines accuracy of the position data based on vehicle body data of the work vehicle and the position data.

2. The determination system according to claim 1, comprising an estimation unit that estimates a value related to a movement amount of a work vehicle based on vehicle body data of the work vehicle,
wherein the determination unit determines accuracy of the position data based on the value related to the movement amount and the position data.

3. The determination system according to claim 2, wherein the determination unit determines that the position data is accurate when a difference between the value related to the movement amount and the position data when being converted into a same type of amount is smaller than a predetermined threshold.

4. The determination system according to claim 3, wherein
the estimation unit further outputs reliability of the value related to the movement amount of the work vehicle, and
the determination unit determines that the position data is accurate when the reliability is greater than or equal to a predetermined threshold and a difference when the value related to the movement amount and the position data are converted into a same type of amount is smaller than a predetermined threshold.

5. The determination system according to claim 1, wherein
the determination unit determines accuracy of position data by inputting vehicle body data and the position data to a learned model learned to output the accuracy of the position data from the vehicle body data of the work vehicle and the position data measured based on the GNSS.

6. The determination system according to claim 2, wherein the estimation unit estimates a value related to a movement amount by inputting vehicle body data to a learned model learned to output the value related to the movement amount from the vehicle body data.

7. The determination system according to claim 1, wherein the vehicle body data includes a value related to power of a traveling body of the work vehicle.

8. The determination system according to claim 1, wherein the vehicle body data includes a value related to a state of a work machine of the work vehicle.

9. The determination system according to claim 1, wherein the vehicle body data further includes measurement data of an imaging device that images an outside of the work vehicle.

10. A determination method comprising:
a step of acquiring position data indicating a position of a work vehicle based on a global navigation satellite system (GNSS); and
a step of determining accuracy of the position data based on vehicle body data of the work vehicle and the position data.

11. The determination system according to claim 3, wherein the estimation unit estimates a value related to a movement amount by inputting vehicle body data to a learned model learned to output the value related to the movement amount from the vehicle body data.

12. The determination system according to claim 4, wherein the estimation unit estimates a value related to a movement amount by inputting vehicle body data to a learned model learned to output the value related to the movement amount from the vehicle body data.

13. The determination system according to claim 2, wherein the vehicle body data includes a value related to power of a traveling body of the work vehicle.

14. The determination system according to claim 3, wherein the vehicle body data includes a value related to power of a traveling body of the work vehicle.

15. The determination system according to claim 4, wherein the vehicle body data includes a value related to power of a traveling body of the work vehicle.

16. The determination system according to claim 2, wherein the vehicle body data includes a value related to a state of a work machine of the work vehicle.

17. The determination system according to claim 3, wherein the vehicle body data includes a value related to a state of a work machine of the work vehicle.

18. The determination system according to claim 4, wherein the vehicle body data includes a value related to a state of a work machine of the work vehicle.

19. The determination system according to claim 2, wherein the vehicle body data further includes measurement data of an imaging device that images an outside of the work vehicle.

20. The determination system according to claim 3, wherein the vehicle body data further includes measurement data of an imaging device that images an outside of the work vehicle.
